(19) United States
(12) Patent Application Publication
(10) Pub. No.: US 2010/0211714 A1
(43) Pub. Date: Aug. 19, 2010

(54) METHOD, SYSTEM, AND APPARATUS FOR TRANSFERRING DATA BETWEEN SYSTEM MEMORY AND INPUT/OUTPUT BUSSES

(75) Inventor: Brian J. LePage, Shoreview, MN (US)

Correspondence Address: UNISYS CORPORATION, UNISYS WAY, MAIL STATION: S1-108, BLUE BELL, PA, 19424, US

(73) Assignee: Unisys Corporation

(21) Appl. No.: 12/371,055

(22) Filed: Feb. 13, 2009

(51) Int. Cl. G06F 13/372

(52) U.S. Cl. 710/310

(57) ABSTRACT

Transferring data between system memory and input/output busses involves determining, via a request buffer, a memory-mapped, input/output (I/O) read request targeted for a first-in-first-out (FIFO) I/O device. The read request is targeted to a request address in a prefetchable memory space corresponding to the I/O device. It is determined whether the request address corresponds to an expected address in the prefetchable memory space. The expected address is determined based on one or more previous read requests targeted to the prefetchable memory space. The read request is reordered in the request buffer if the request address does not correspond to the expected address. The read request is fulfilled if the address corresponds to the expected address.

### FIELD OF THE INVENTION

The present invention relates in general to computer architectures, and more particularly to transferring data between system memory and input/output busses.

### BACKGROUND OF THE INVENTION

The efficient performance of input and output operations is an important aspect of computer system design. Contemporary large-scale computer systems typically interface with many different attached peripheral devices such as magnetic disk drives, optical disk drives, magnetic tape drives, cartridge tape libraries, network interfaces, and the like. A robust mechanism should thus be provided to send output to, and receive input from, such devices. Further, such systems should be adaptable to use off-the-shelf storage interface device to take advantage of the low cost and high performance now available in commodity devices.

The Peripheral Component Interconnect (PCI) standard is widely used data interface standard. As a result, a large number of internal computer input/output (I/O) devices on the market are designed to be compatible with some type of PCI standard. Although many currently available devices comply with the original PCI standard, newer standards such as PCI-eXtended (PCI-X) and PCI Express (PCIe) standards have evolved that offer higher performance than PCI. PCI-X is a version of PCI that can run up to eight times the clock speed. Otherwise, the PCI-X electrical implementation and protocol is similar to the original PCI. PCIe was designed to replace PCI and PCI-X. Rather than being a shared parallel bus like PCI and PCI-X, PCIe is structured around point-to-point serial links.

Most modern computing systems handle data in multi-byte formats, such as those that utilize 32-bit and 64-bit processors. In addition, some Cellular Multi-Processing (CMP) systems handle data in memory in the form of 36-bit words. Off-the-shelf storage devices operate with 8-bit bytes. When data is moved to a storage device, it must be re-formatted to make efficient use of the storage space on the target device. For example, in a 36-bit system, a data formatter device is used to convert the data from a 36-bit word format to an 8-bit byte aligned word format. The formatter device uses a First-In-First-Out (FIFO) buffer to store the data as a PCI-X/PCI Express Host Bus Adapter (HBA) streams data through the formatter device (and its FIFO buffers) out to the storage device. Because the data must stream through the FIFO in order, the data must be requested in order.

The PCI-X/PCIe HBA's will request data in order but may issue multiple read requests simultaneously (e.g., one after the other without waiting for a read completion) to improve throughput. A PCI-X/PCIe bridge or switch device in the system may optionally reorder these read requests. If this occurs, the FIFO based formatter device will receive the requests out-of-order and could consequently return the incorrect data for some read requests.

The PCI-X and PCI Express specifications solved this problem by requiring that memory-mapped I/O space that targets a FIFO be designated as non-prefetchable memory space. Prefetchable memory is memory that can be read multiple times without side effects. There is no consequence if a device must re-read prefetchable memory due to buffering of data to improve data flow. Likewise, there is no consequence if requests to a prefetchable memory are completed out of order. A random access memory (RAM) is an example of prefetchable memory. In contrast, a read of non-prefetchable memory may have side effects such that it cannot be re-read and requests to non-prefetchable memory must be completed in order. A magnetic tape is an example of a non-prefetchable memory because the act of reading the tape causes the tape to advance. Any requester that reads from non-prefetchable memory space must issue only one read request to that memory space at a time (to prevent re-ordering), and it must also read only 4-bytes of data per read request to prevent bridges from breaking the read request into multiple requests.

The use of non-prefetchable memory makes repeated read operations from the same segment of memory slower. Therefore, accessing memory-mapped I/O space that targets a FIFO without being limited to non-prefetchable memory space is desirable.

### SUMMARY OF THE INVENTION

The present invention is directed to methods, apparatuses, and systems for transferring data between system memory and input/output busses. In one embodiment, a method for transferring data between system memory and input/output busses involves determining, via a request buffer, a memory-mapped, input/output (I/O) read request targeted for a first-in-first-out (FIFO) I/O device. The read request is targeted to a request address in a prefetchable memory space corresponding to the I/O device. It is determined whether the request address corresponds to an expected address in the prefetchable memory space. The expected address is determined based on one or more previous read requests targeted to the prefetchable memory space. If the request address does not correspond to the expected address, the read request is reordered in the request buffer, otherwise the read request is fulfilled if the address corresponds to the expected address.

In more particular aspects, the method may further involve updating the expected address based on a number of bits transferred in the read request. In such a case, the method may further involve storing the updated expected address in a register associated with the prefetchable memory space. In other particular aspects, the I/O device may include any combination of a Peripheral Component Interconnect eXtended device and a Peripheral Component Interconnect Express device.

In other more particular aspects of the method, fulfilling the read request may involve translating between a multi-byte word format of system memory to a single byte format of the I/O device via a FIFO queue. In such a case, the multi-byte word format may include a 36-bit word format.

In another embodiment, an apparatus includes a read request buffer capable of storing addresses of memory-mapped, input/output (I/O) read requests targeted for a first-in-first-out (FIFO) I/O device. The read requests are targeted to respective request addresses in a prefetchable memory space corresponding to the I/O device. A logic block is coupled to the read request buffer and configured with instructions that cause the logic block to: a) determine, via the read request buffer, a request address of one of the read requests; b) determine whether the request address corresponds to an expected address in the prefetchable memory space (the expected address is determined based on one or more previous read requests targeted to the prefetchable memory space); c) reorder the read request in the request buffer if the request address does not correspond to the expected address; and d) fulfill the read request if the address corresponds to the expected address.

In more particular aspects, the instructions may further cause the logic block to update the expected address based on a number of bits transferred in the read request. In such a case, the instructions may further cause the logic block store the updated expected address in a register associated with the prefetchable memory space.

In other more particular aspects, the apparatus may further include a plurality of FIFO queues coupled to the logic block via a multiplexer. The one or more of the FIFO queues are associated with the targeted I/O device. In such a case, the apparatus may also include a plurality of expected address registers coupled to the logic block. Each of the FIFO queues are associated with one of the expected address registers, and in such a case the instructions further cause the logic block to retrieve the expected address from the expected address registers.

In another embodiment, an apparatus includes a read request buffer capable of storing addresses of memory-mapped, input/output (I/O) read requests targeted for a first-in-first-out (FIFO) I/O device. The read requests are targeted to respective request addresses in a prefetchable memory space corresponding to the I/O device. The address also includes: a) means for determining, via the read request buffer, a request address of one of the read requests; b) means for determining whether the request address corresponds to an expected address in the prefetchable memory space, wherein the expected address is determined based on one or more previous read requests targeted to the prefetchable memory space; c) means for reordering the read request in the request buffer if the request address does not correspond to the expected address; and d) means for fulfilling the read request if the address corresponds to the expected address.

In other more particular aspects, the apparatus may further include means for associating a plurality of FIFO queues with a plurality of I/O devices comprising the targeted I/O device. In such a case, the apparatus may also include means for associating a plurality of expected address registers with the plurality of FIFO queues and providing the expected address in response to determining the request address.

These and various other advantages and features of novelty are pointed out with particularity in the claims annexed hereto and form a part hereof However, for a better understanding of the invention, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

FIG. 1 is a block diagram illustrating a computing system according to an embodiment of the invention;

FIG. 2 is a block diagram illustrating a formatting device according to an embodiment of the invention;

FIG. 3 is a flowchart illustrating a procedure for reordering read requests according to an embodiment of the invention; and

FIG. 4 is a flowchart illustrating a procedure for transferring data between system memory and input/output busses according to an embodiment of the invention.

### DETAILED DESCRIPTION

Generally, the described embodiments are directed to a method, system, and apparatus for tolerating out-of-order memory-mapped read requests that target a FIFO-based I/O device. In such methods, systems, and apparatuses, previously successful read requests are tracked, and the expected address of the next read request calculated. When an unexpected read is received, read requests are re-ordered to ensure the returned data is in the correct order.

Generally, the term “expected address” may refer to, but is not limited to, the next subsequent address of a memory access (e.g., read/write) that would be expected/predicted based on the immediately previous memory access request. For example, if software issues a series of read requests targeted to a FIFO-based device that is mapped to a large contiguous block of memory, the expected address may be calculated by the previous read address offset by the amount of memory read in the previous request. A FIFO-based device will generally expect memory accesses to occur in such an ordered fashion, e.g., in a manner similar to read/writes from/to a tape drive. Thus read requests must be returned in the expected order.

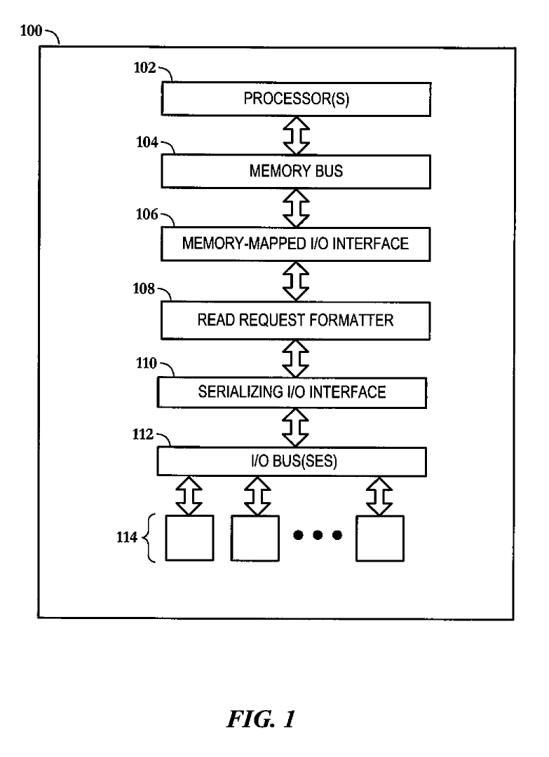

In FIG. 1, a block diagram illustrates a processing system 100 in which methods, apparatus, and computer programs according to embodiments of the invention may be employed. The processing system 100 may be a general-purpose or special-purpose processing apparatus that employs one or more central processing units 102. The processors 102 are coupled to a memory bus 104 that provides access to memory such as system memory and input/output (I/O) devices. A memory-mapped I/O interface 106 provides access to the latter. The I/O subsystems include at least one I/O interface 110 that serializes or otherwise rearranges bit order/arrangement of data communicated between the memory interface 106 and I/O busses 112. The I/O busses 112 provide access to target I/O devices 1 14 using circuitry and protocols known in the art.

The memory mapped I/O interface 110 may allow simultaneous read requests to be submitted to the same memory block that is allocated to a particular device 114. When the data read request is targeted to a FIFO device, this may lead to data that is returned out of order. As described in greater detail hereinabove, in specifications such as PCI-X and PCIe, memory-mapped, FIFO, I/O read requests are required to be non-prefetchable to ensure responsive data is not returned out of order. To relax this requirement, the illustrated system includes a read request formatter 108 that allows memory mapped I/O requests to be made prefetchable without causing erroneous data reads. In this system 100, requestors for I/O (such as PCI-X/PCIe devices) can issue multiple read requests and burst large amounts of data from a FIFO-based device, greatly improving read performance. Also, because the system 100 tolerates out-of-order requests, it may re-order read requests, such that a request for one I/O transaction may not be blocked by another request when data is not yet available to fulfill the request. This prevents stalls that would otherwise degrade the throughput of the system 100.

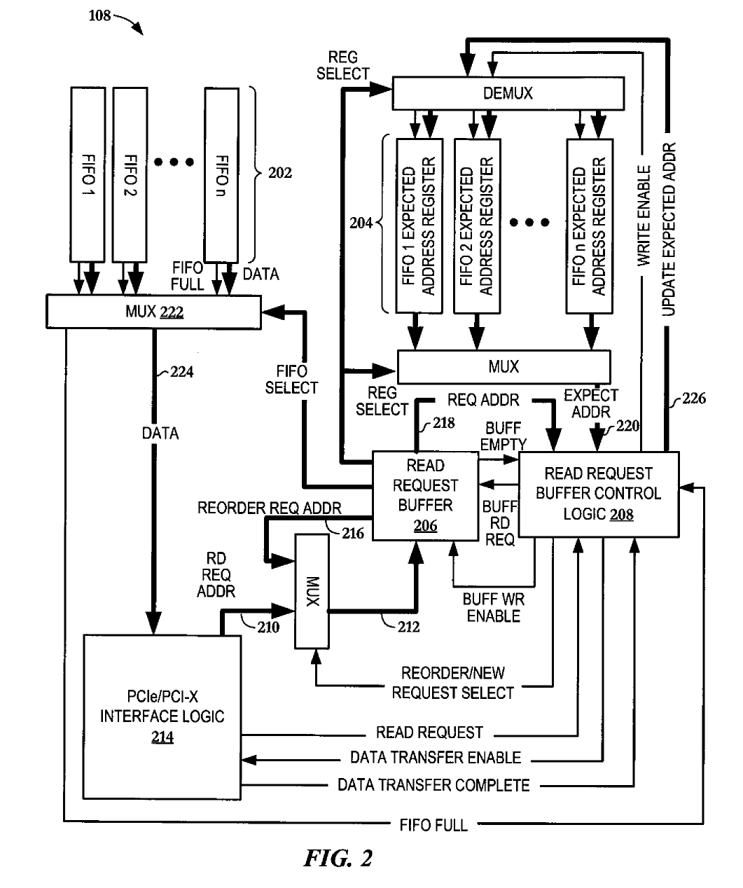

In reference now to FIG. 2, a block diagram shows functional components of the formatter device 108 according to an example embodiment of the invention. The formatter device can support several I/O transactions simultaneously, and may be adapted for single processor and/or cellular multiprocessing computing arrangements. For each supported I/O transaction, there is a separate FIFO buffer as represented by buffers 202. An I/O transaction may involve several thousand bytes of data transferred with many read requests issued by a host bus adapter (HBA).

The illustrated embodiment includes three components that work together to allow the FIFO-Based formatter device to tolerate out-of-order read requests: one or more expected address registers 204 for each supported I/O transaction; a read request buffer 206; and a read request buffer control logic block 208. Each expected address register 204 stores, for a respective one of the FIFOs 202, the expected address for the next read request. The read request buffer 206 stores the addresses of several pending read requests initiated on a PCI-X/PCIe interface 214, as communicated to the buffer 206 via paths 210 and 212. The PCI-X/PCIe interface 214 may be included as part of device 108, or may be external, e.g., part of interface 1 10 shown in FIG. 1.

The read request buffer control logic block 208 monitors the read request buffer 206 and decides whether the request may be serviced or must be returned to the back of the buffer 206 because the request has been re-ordered. When a read request is received on the PCI-X/PCIe interface 214, the address of this request is stored in the buffer 206. All requests in the buffer 206 are serviced in the order they are received. If an unexpected address appears at the front of the buffer 206, this request is moved to the back of the buffer 206 as represented by path 216, thereby re-ordering the requests again until an expected address appears at the front of the buffer 206.

For each supported I/O transaction (represented by FIFOs 202) there is one expected address register 204. When an I/O is initialized, this register 204 is cleared, so the expected address for that I/O is zero. When a valid read request appears at the front of the read request buffer 206 via path 210, the read request buffer logic 208 compares the address (received via path 218) to the expected address (received via path 220) from the appropriate expected address register 204. If the addresses 218, 220 do not match, the request is moved to the back of the read request buffer 206 via paths 216, 212, postponing the data transfer.

If the addresses 218, 220 match, data is transferred via multiplexer 222 and path 224. An updated expected address is calculated by the logic 208 based on the previous expected address and the number of bytes transferred to the requester. The logic 208 then updates the appropriate register 204 via path 226 with the updated expected address.

For purposes of illustration, the operation of the formatter 108 is described in terms of functional circuit/software/firmware modules that interact to provide particular results as are described herein. Those skilled in the art will appreciate that other arrangements of functional modules are possible. Further, one skilled in the art can implement such described functionality, either at a modular level or as a whole, based on the description provided herein. The formatter 108 circuitry is only a representative example of hardware that can be used to read request reordering for FIFO-based I/O as described herein.

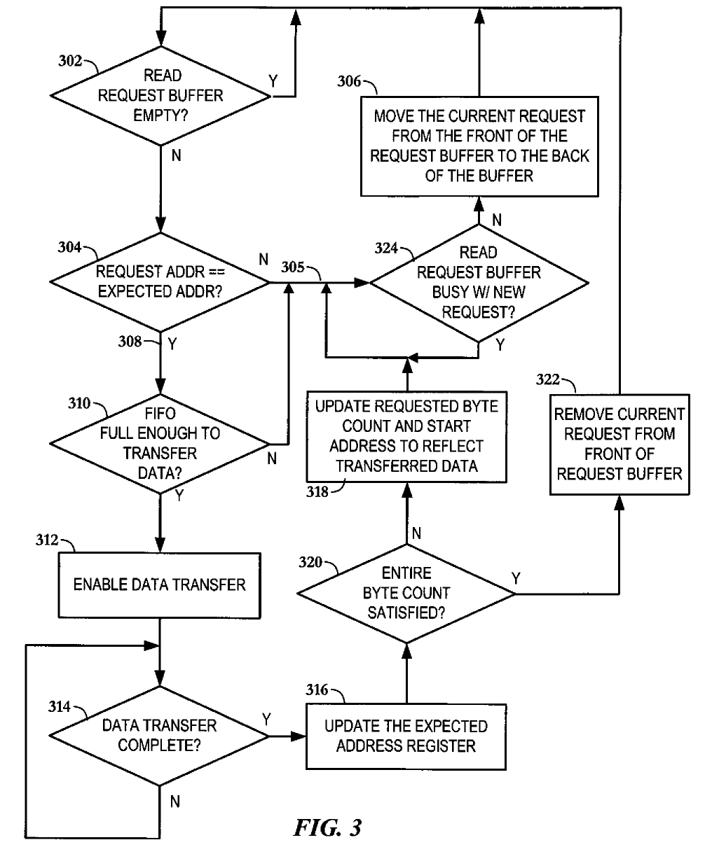

In reference now to FIG. 3, a flowchart illustrates how the read request buffer control logic may operate according to an example embodiment of the invention. In the description that follows, reference is made to components shown and described in relation to the block diagram of FIG. 2. Those of skill in the art will appreciate that alternate components may provide analogous functionality, and the reference to components of FIG. 2 is made for purposes of illustration, and not limitation. Generally, the flowchart shown in FIG. 3 operates in a continuous loop that continues to function so long as the system of the block diagram of FIG. 2 continues to operate.

When a read request appears at the front of the read request buffer 206 (e.g., buffer not empty as shown in decision block 302), the appropriate expected address register 204 is selected based on the upper bits of the address. The read request buffer control logic block 208 then compares 304 the contents of the expected address register 204 to the lower bits of the address.

If the bits do not match (as indicated by path 305), the request is removed from the read request buffer 206 and moved 306 to the back of the buffer when the buffer 206 is not busy accepting a new read request 324. If the lower bits of the address match the contents of the expected address register 204 (as indicated by path 308), the read request buffer control logic 208 checks 310 the data FIFO 202 to see if there is enough data available to begin a data transfer on the PCI-X/PCIe interface 214. If so, the data transfer occurs 312, 314. Otherwise, the request is moved 306 to the back of the buffer as though it was out-of-order to keep the request from blocking other I/O transactions while data is moved into the data FIFO. If data is transferred on the PCI-X/PCIe interface, the read request buffer control logic 208 will wait 314 for the transfer to complete. Once the transfer has completed, the expected address register 204 is updated 316 by the amount of data transferred.

If more data must be transferred to fulfill the read request (as determined at 320), the read request's byte count is decremented, and its address is incremented 318. The request is then moved 306 to the back of the read request buffer 206 to be completed later. If the entire byte count of the read request was satisfied, the current read request is removed 322 from the read request buffer 206. The read request buffer control logic 208 then processes the next request in the buffer, if one is available (e.g., determined at 302).

After updating the requested byte count and start address 318 or after determining that there is not enough data available in the data FIFO 202 (as determined at 310), the read request control logic 208 must check whether the read request buffer 206 is busy receiving a new request from the PCIe/PCI-X interface logic 214. If the read request buffer 206 is busy (as determined at 324), the read request buffer control logic 208 must wait 324 until the read request buffer 206 is no longer busy before proceeding to move the current request 306 to the back of the read request buffer 206.

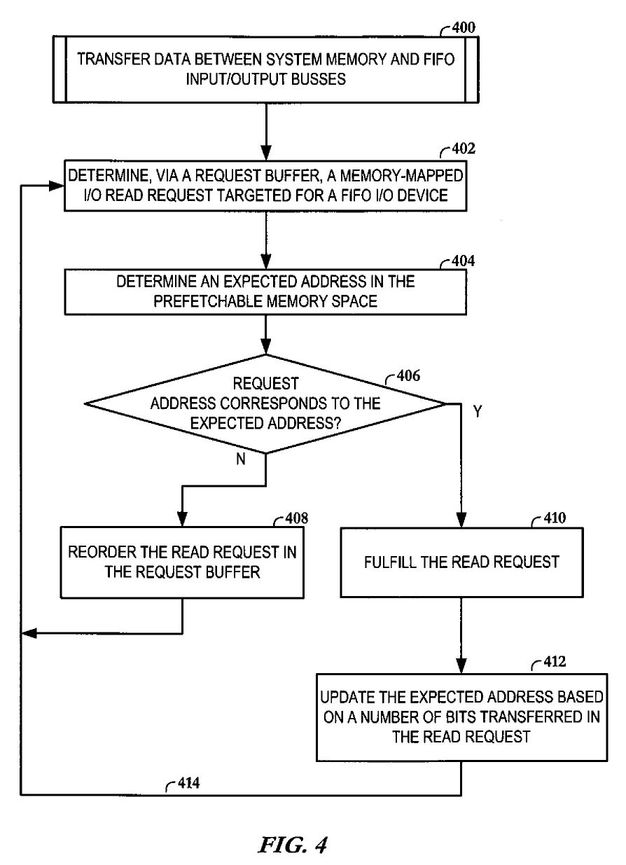

In reference now to FIG. 4, a flowchart illustrates a procedure 400 for transferring data between system memory and FIFO input/output busses according to an embodiment of the invention. The procedure involves determining 402, via a request buffer, a memory-mapped, I/O read request targeted for a FIFO I/O device. The read request is targeted to a request address in a prefetchable memory space corresponding to the FIFO device. An expected address in the prefetchable memory space is determined 404 based on one or more previous read requests targeted to the prefetchable memory space.

The procedure 400 determines 406 if the request address corresponds to the expected address. If not, the read request is reordered 408 in the request buffer, e.g., placed at the end of the request buffer. Otherwise, the read request is fulfilled 410 and the expected address is updated 412 based on a number of bits transferred in the read request. As indicated by path 414, this procedure 400 may continue to service read requests in an infinite loop.

Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims

What is claimed is:

1. A method for transferring data for transferring data between system memory and input/output busses in a computer system having one or more processors coupled to a memory system having one or more memory units, and an input/output system having one or more busses, the method comprising:
determining, via a request buffer, a memory-mapped input/output (I/O) read request targeted for a first-in-first-out (FIFO) I/O device, wherein the read request is targeted to a request address in a prefetchable memory space corresponding to the I/O device;
determining whether the request address corresponds to an expected address in the prefetchable memory space, wherein the expected address is determined based on one or more previous read requests targeted to the prefetchable memory space;
reordering the read request in the request buffer if the request address does not correspond to the expected address; and
fulfilling the read request if the address corresponds to the expected address.

2. The method according to claim 1, further comprising updating the expected address based on a number of bits transferred in the read request.

3. The method according to claim 2, further comprising storing the updated expected address in a register associated with the prefetchable memory space.

4. The method of claim 1, wherein the I/O device comprises a Peripheral Component Interconnect eXtended device.

5. The method of claim 1, wherein the I/O device comprises a Peripheral Component Interconnect Express device.

6. The method of claim 1, wherein fulfilling the read request comprises translating between a multi-byte word format of system memory to a single byte format of the I/O device via a FIFO queue.

7. The method of claim 6, wherein the multi-byte word format comprises a 36-bit word format.

8. An apparatus for transferring data in a computer system having one or more processors coupled to a memory system having one or more memory units, and an input/output system having one or more busses, the apparatus comprising:
a read request buffer capable of storing addresses of memory-mapped, input/output (I/O) read requests targeted for a first-in-first-out (FIFO) I/O device, wherein the read requests are targeted to respective request addresses in a prefetchable memory space corresponding to the I/O device;
a logic block coupled to the read request buffer and configured with instructions that cause the logic block to:
determine, via the read request buffer, a request address of one of the read requests;
determine whether the request address corresponds to an expected address in the prefetchable memory space, wherein the expected address is determined based on one or more previous read requests targeted to the prefetchable memory space;
reorder the read request in the request buffer if the request address does not correspond to the expected address; and
fulfill the read request if the address corresponds to the expected address.

9. The apparatus according to claim 8, wherein the instructions further cause the logic block to update the expected address based on a number of bits transferred in the read request.

10. The apparatus according to claim 9, wherein the instructions further cause the logic block to store the updated expected address in a register associated with the prefetchable memory space.

11. The apparatus of claim 8, wherein the I/O device comprises a Peripheral Component Interconnect eXtended device.

12. The apparatus of claim 8, wherein the I/O device comprises a Peripheral Component Interconnect Express device.

13. The apparatus of claim 8, wherein fulfilling the read request comprises translating between a multi-byte word format of system memory to a single byte format of the I/O device via a FIFO queue.

14. The apparatus of claim 13, wherein the multi-byte word format comprises a 36-bit word format.

15. The apparatus of claim 8, further comprising a plurality of FIFO queues coupled to the logic block via a multiplexer, wherein one or more of the FIFO queues are associated with the targeted I/O device.

16. The apparatus of claim 15, further comprising a plurality of expected address registers coupled to the logic block, wherein each of the FIFO queues are associated with one of the expected address registers, and wherein the instructions further cause the logic block to retrieve the expected address from the expected address registers.

17. An apparatus for transferring data in a computer system having one or more processors coupled to a memory system having one or more memory units, and an input/output system having one or more busses, the apparatus comprising:
a read request buffer capable of storing addresses of memory-mapped, input/output (I/O) read requests targeted for a first-in-first-out (FIFO) I/O device, wherein the read requests are targeted to respective request addresses in a prefetchable memory space corresponding to the I/O device;
means for determining, via the read request buffer, a request address of one of the read requests;
means for determining whether the request address corresponds to an expected address in the prefetchable memory space, wherein the expected address is determined based on one or more previous read requests targeted to the prefetchable memory space;
means for reordering the read request in the request buffer if the request address does not correspond to the expected address; and
means for fulfilling the read request if the address corresponds to the expected address.

18. The apparatus of claim 17, further comprising means for associating a plurality of FIFO queues with a plurality of I/O devices comprising the targeted I/O device.

19. The apparatus of claim 18, further comprising means for associating a plurality of expected address registers with the plurality of FIFO queues and providing the expected address in response to determining the request address.
